(19) United States
(12) Patent Application Publication
(10) Pub. No.: US 2007/0104480 A1
(43) Pub. Date: May 10, 2007

(54) Single-lens reflex camera

(76) Inventors: Toshikatsu Shiozaki, Tokyo (JP); Naoki Fujikawa, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/591,901

(22) Filed: Nov. 1, 2006

(30) Foreign Application Priority Data
Nov. 4, 2005 (JP) 2005-320512

(51) Int. Cl. G03B 9/38

(52) U.S. Cl. 396/492

(57) ABSTRACT

The single-lens reflex camera of present invention features its shutter device. The shutter device includes a support plate having an opening through which an imaging medium is exposed to a light beam from a subject, a shutter blade for opening and closing the opening, and a shutter control part for driving opening and closing movement of the shutter blade, wherein the shutter control part is located behind the support plate along the optical axis of the subject light beam.

### CROSS-REFERENCE TO RELATED APPLICATION

This application is based upon and claims the benefit of priority from prior Japanese Patent Application No. 2005-320512, filed on Nov. 4, 2005, the entire contents of which are incorporated herein by reference.

### BACKGROUND OF THE INVENTION

1. Field of the Invention

The present invention relates to a single-lens reflex camera with a built-in focal-plane shutter.

2. Description of the Related Art

The single-lens reflex camera typically incorporates a so-called focal-plane shutter. In the focal-plane shutter, a driving force generated by a motor or human power is transmitted to a mechanism having a pair of shutter blades, which form front and rear curtains respectively, to charge springs, and magnets (electromagnet) keep the shutter blades in charged condition. Then, when a shutter button is pressed, a release signal is generated to de-energize each magnet at predetermined timing so that each of the pair of shutter blades is released from its charged state to travel individually under the force of each spring, thereby obtaining a predetermined exposure.

Referring to FIGS. 5 to 7, the structure of a conventional single-lens reflex camera is schematically described below. FIG. 5 is a transversal-sectional view showing the layout of each of mechanisms as viewed from the upper side of the single-lens reflex camera. FIG. 6 is an exploded perspective view of the single-lens reflex camera. FIG. 7 is a schematic exploded perspective view of a charge device.

As shown in FIG. 5, an imaging medium 14 such as a CCD, a low-pass filter 16, a shutter device (focal-plane shutter) 18, a mirror box device 20, and a camera front plate 22 are arranged in this order in front of an electric substrate 12 along the optical axis O of a light beam from a subject inside a camera body 11 of a single-lens reflex camera 10. A lens unit (not shown) is removably mounted on the camera body 11 through a body mount 22a of the front plate 22. Further, a charge device 19 is arranged at the side of the mirror box device 20.

As shown in FIGS. 6 and 7 together with FIG. 5, the shutter device 18 has a box-shaped shutter control part 18a and a support plate (shutter base plate) 18b supporting the shutter control part 18a. The shutter control part 18a includes a pair of shutter blades 18a1 fitted in and held by the support plate 18b to function as front and rear curtains respectively, magnets (not shown) typically electromagnets, and charge springs (not shown). The shutter blade pair 18a1 is fitted in and held by the support plate 18b.

The charge device 19 has a motor 19a and a driving-force transmission mechanism 19b including a reduction gear train. The driving force of the motor 19a is slowed down through the driving-force transmission mechanism 19b and transmitted to the shutter control part 18a of the shutter device 18 to charge the charge springs.

The shutter control part 18a of the shutter device 18 is disposed on one lateral side (left-hand side in FIG. 5) of the support plate 18b and located in front of the support plate 18b in the direction of the optical axis O. On the other hand, the charge device 19 is arranged at the side of the mirror box device 20 to occupy part of the space in front and side of the shutter device 18 (specifically the shutter control part 18a). A portion of the charge device 19 also occupies the space below the bottom of the shutter device 18 (specifically the shutter control part 18a).

Thus, the shutter control part 18a of the shutter device 18 and the charge device 19 are both located in front of the support plate 18b in the direction of the optical axis O.

In general, the shutter control part 18a is arranged transversely not to interfere with the front plate 22. The charge device 19 is arranged in a manner to occupy the space around the front, one side, and bottom of the shutter control part 18a, and its motor 19a is placed near the side of the shutter control part 18a. This arrangement means that the charge device 19 extends out farther laterally than the shutter control part 18a.

In other words, when the length of the shutter control part 18a from the optical axis O to its outer edge (equal to the length of the front plate 22 from the optical axis O to its outer edge) is set to A, the length A′ of the charge device 19 from the optical axis O to its outer edge becomes A+ΔA. This means that the charge device 19 extends laterally out by ΔA from the shutter control part 18a.

The structure of the charge device 19 is known. Briefly, as shown in FIG. 7, the driving force of the motor 19a is transmitted from a pinion gear a of the motor 19a to a charge gear c through the reduction gear train b that slows the rotation speed down. A contact roller e1 of a charge lever e is in contact with a cam surface d1 of a charge cam d on the upper surface of the charge gear c. The charge lever e is swingable about an axis Oe as a pivot point. When the charge gear c rotates in one direction (X direction in FIG. 7) by the driving force of the motor 19a, the charge lever e swings about the axis Oe in the Y direction in FIG. 7 so that a pressure roller e2 provided at the tip of the charge lever e will push a charged lever f of the shutter control part 18a. When the charged lever f is pushed, the charge springs (not shown) of the shutter control part 18a are charged with the driving force of the motor 19a.

Thus, the driving-force transmission mechanism 19b includes the pinion gear a of the motor 19a, the reduction gear train b, the charge gear c, the charge cam d, the charge lever e, and the charged lever f.

When the shutter button is pressed, each of the magnets is de-energized at predetermined timing to release each of the pair of shutter blades 18a1 from being retained in a closed position so that they will travel individually and sequentially under the force of each of the charge springs to obtain a predetermined exposure.

Thus, in the conventional single-lens reflex camera, the shutter control part 18a is arranged on one lateral side of the support plate 18b. On the other hand, the charge device 19 is arranged at the side of the mirror box device 20 in a manner to occupy the space around the front, one side, and bottom of the shutter control part 18a. In other words, the shutter control part 18a of the shutter device 18 and the charge device 19 are both located in front of the support plate 18b in the direction of the optical axis O. Further, a portion of the charge device 19 extends laterally out over the shutter control part 18a. As discussed above, in the conventional single-lens reflex camera, the shutter control part 18a of the shutter device 18 and the charge device 19 are both located in front of the support plate 18b in the direction of the optical axis O. Further, a portion of the charge device 19 extends laterally out over the shutter control part 18a.

### BRIEF SUMMARY OF THE INVENTION

The single-lens reflex camera of the present invention features its shutter device. The shutter device includes a support plate having an opening through which an imaging medium is exposed to a light beam from a subject, a shutter blade for opening and closing the shutter (opening), and a shutter control part for driving open and close movements of the shutter blade, in which the shutter control part is located behind the support plate in the direction of the optical axis of the subject light beam.

As an exemplary structure of the present invention, a single-lens reflex camera comprises an imaging medium and a shutter device arranged in front of the imaging medium along the optical axis of the imaging medium, wherein the shutter device comprises a support plate having an opening through which the imaging medium is exposed to a light beam from a subject, a pair of shutter blades which travel vertically with respect to the optical axis of the subject light beam to control the amount of exposure to the imaging medium, and a shutter control part as a drive part for driving the pair of shutter blades, which is located at the side of the opening and behind the support plate in the direction of the optical axis.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a transversal-sectional view showing the layout of each of mechanisms as viewed from the upper side of a single-lens reflex camera according to a first embodiment of the present invention;

FIG. 2 is an exploded perspective view of the single-lens reflex camera of the present invention;

FIG. 3 is a schematic exploded perspective view of a charge device for a shutter for a shutter according to the present invention;

FIG. 4 is a transversal-sectional view showing the layout of each of mechanisms as viewed from the upper side of a single-lens reflex camera according to a second embodiment of the present invention;

FIG. 5 is a transversal-sectional view showing the layout of each of mechanisms as viewed from the upper side of a conventional single-lens reflex camera;

FIG. 6 is an exploded perspective view of the conventional single-lens reflex camera; and

FIG. 7 is a schematic exploded perspective view of a charge device for a conventional shutter.

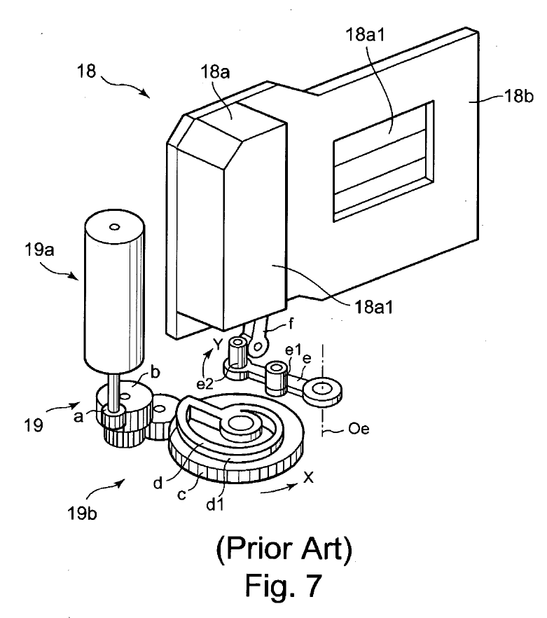

### DETAILED DESCRIPTION OF THE PREFERRED EMBODIMENTS

Preferred embodiments of the invention are described below with reference to the accompanying drawings.

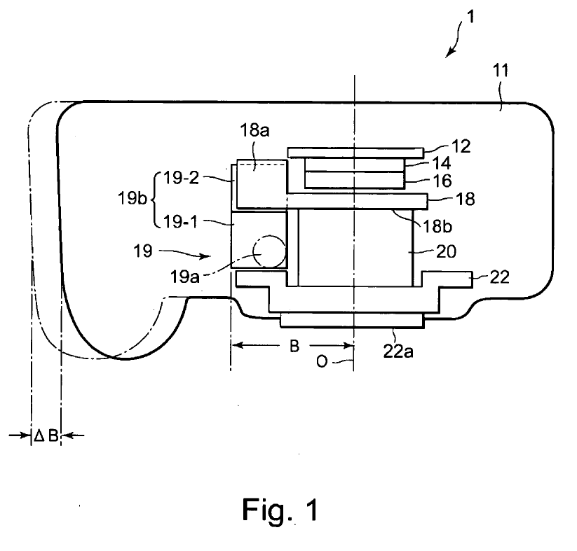

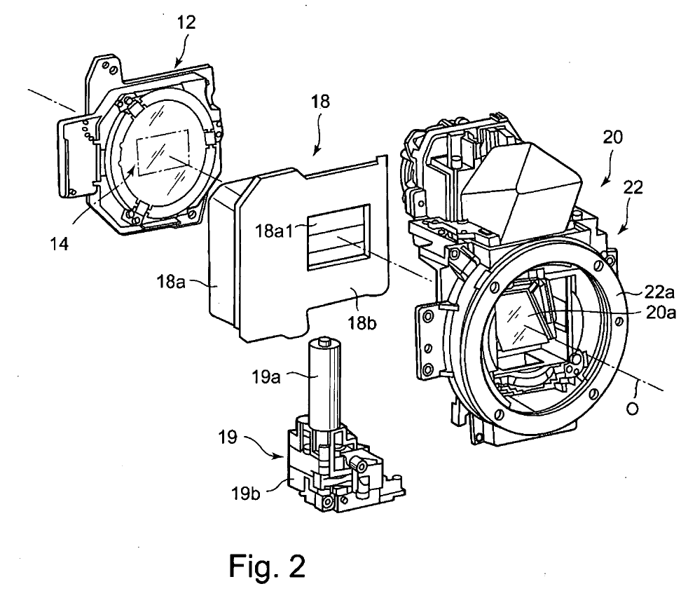

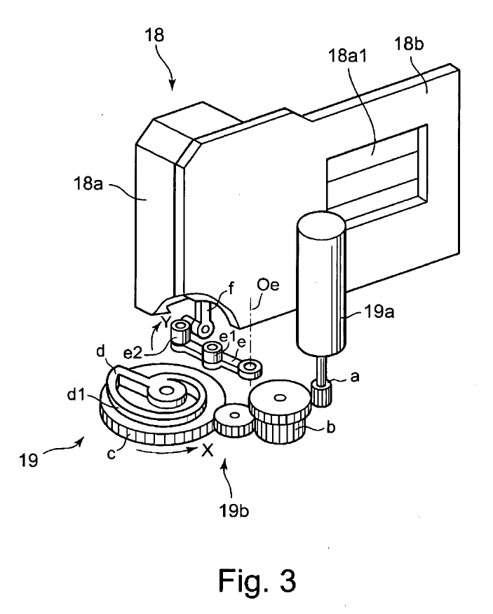

FIG. 1 is a transversal-sectional view showing the layout of each of mechanisms as viewed from the upper side of a single-lens reflex camera according to a first embodiment of the present invention. FIG. 2 is an exploded perspective view of the single-lens reflex camera. FIG. 3 is a schematic exploded perspective view of a charge device.

In the embodiment, a shutter control part is disposed on one lateral side of a support plate and located behind the support plate in the direction of an optical axis. Since the shutter control part is located behind the support plate in the direction of the optical axis, there is no need to provide space for the shutter control part in front of the support plate in the direction of the optical axis. Therefore, the front space can be used effectively for other purposes.

For example, part or entire of the charge device for charging the shutter control part can be arranged in the space. In this case, the charge device can be arranged without extending farther out from the side of the shutter control part. This can improve flexibility in designing the camera. In particular, if the charge device has a motor, the motor can be placed closer to the optical axis. This can shorten the length of the charge device from the optical axis to its outer edge, and hence is effective in downsizing the single-lens reflex camera.

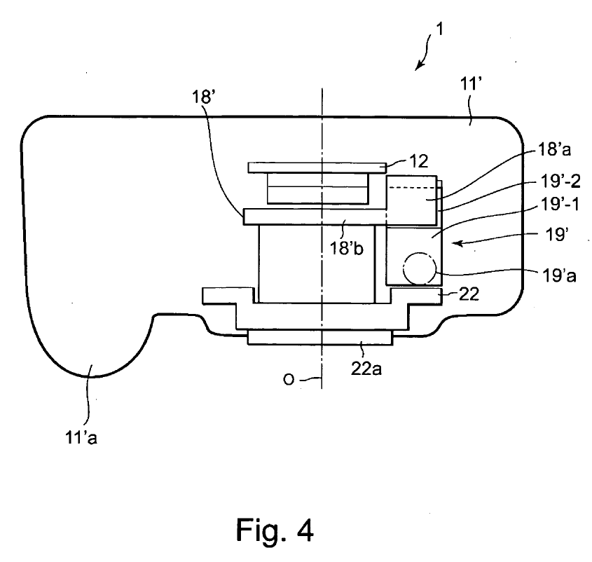

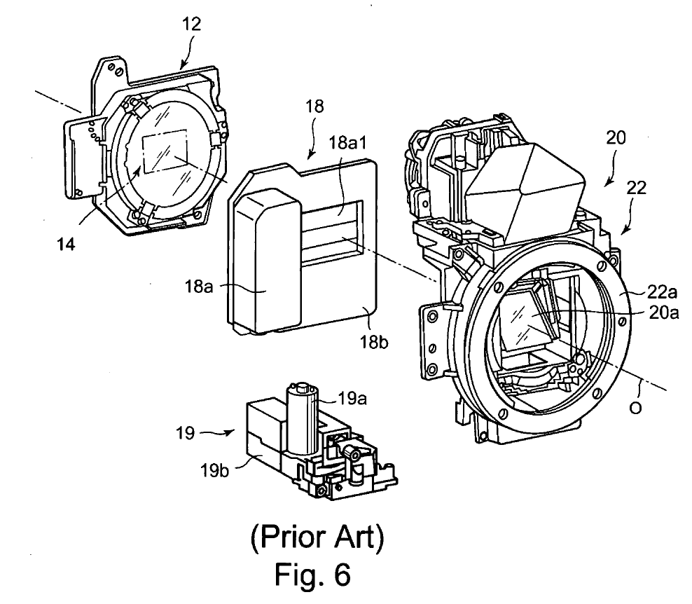

The single-lens reflex camera of the present embodiment is basically the same in terms of components as the conventional single-lens reflex camera shown in FIGS. 4 to 6, except merely for a small portion of the layout. Therefore, in the following description, the same reference numerals are used to designate the same components as those in the conventional single-lens reflex camera.

As shown in FIG. 1, an imaging medium 14 such as a CCD, a low-pass filter 16, a shutter device (focal-plane shutter) 18, a mirror box device 20, and a front plate 22 are arranged in this order in front of an electric substrate 12 along the optical axis O of a light beam from a subject inside a camera body 11 of a single-lens reflex camera 1. A charge device 19 is arranged at the side of the mirror box device 20. Further, a lens unit (not shown) is removably mounted on the camera body 11 through a body mount 22a of the front plate 22.

The shutter device 18 has a box-shaped shutter control part 18a and a support plate (shutter base plate) 18b supporting the shutter control part 18a. The shutter control part 18a includes a pair of shutter blades 18a1 fitted in and held by the support plate 18b to function as front and rear curtains respectively, magnets (not shown) typically electromagnets, and charge springs (not shown). The shutter blade pair 18a1 is fitted in and held by the support plate 18b.

On the other hand, the charge device 19 has a motor 19a and a driving-force transmission mechanism 19b including a reduction gear train. The driving force of the motor 19a is slowed down through the driving-force transmission mechanism 19b and transmitted to the shutter control part 18a of the shutter device 18 to charge the charge springs.

The shutter control part 18a is disposed on one lateral side of the support plate 18b and located behind the support plate 18b in the direction of the optical axis O. This location corresponds to one lateral side (left-hand side in FIG. 1) of the shutter device 18. On the other hand, one portion 19-1 of the charge device 19 is arranged at the side of the mirror box device 20 and in front of the shutter control part 18a, while the other portion 19-2 extends below the bottom of the shutter control part 18a across the support plate 18b. In other words, the charge device 19 extends from a position forward of the support plate 18b in the direction of the optical axis to a position below the bottom the shutter control part 18a.

Thus, the shutter control part 18a is mounted on one lateral side of the support plate 18b of the shutter device 18 and located behind the support plate 18b in the direction of the optical axis, while the charge device 19 is arranged to extend from a position forward of the support plate 18b in the direction of the optical axis to a position below the bottom of the shutter control part 18a. It means that the shutter control part 18a and the charge device 19 are arranged in front of and behind the support plate 18b in the direction of the optical axis in a divided manner.

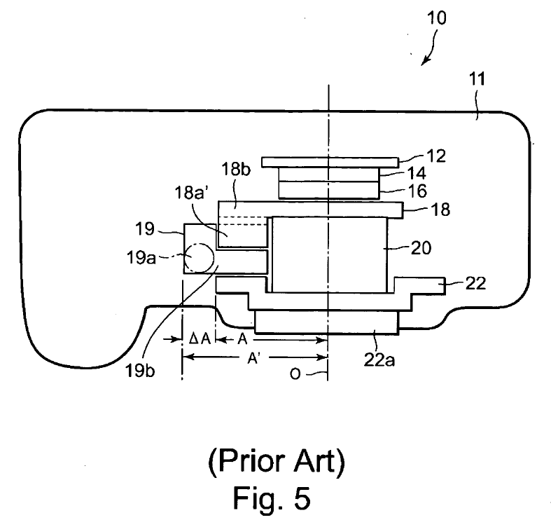

Since the space at the side of and behind the support plate 18b in the direction of the optical axis, on which the shutter control part 18a is arranged in the embodiment, is unused in the conventional structure as shown in FIG. 5, the shutter control part 18a can be arranged in this space without the need for additional space. On the other hand, the charge device 19 is arranged such that one portion 19-1 of the charge device 19 is positioned instead of the shutter control part 18a in FIG. 5 in front of the shutter control part 18a and at the side of the mirror box device 20, where the shutter control part 18a is arranged in the conventional structure, while the other portion 19-2 extends below the bottom of the shutter control part 18a across the support plate 18b.

In the embodiment, when the length of the charge device 19 from the optical axis O to its outer edge is set to B, the motor 19a of the charge device 19 is positioned within the length B, not at the side of the shutter control part 18a.

In this layout, the length B of the charge device 19 from the optical axis O to its outer edge is obviously shorter than the length A′ in the conventional structure in FIG. 5. In FIG. 1, the outline shape of the conventional camera body is indicated by an alternate long and short dashed line. It is apparent from FIG. 1 that the horizontal dimension of the camera body 11 in the embodiment is shorter by ΔB than that in the conventional structure in FIG. 5 (note that the area of the charge device 19 is the same between FIGS. 1 and 5).

Thus, according to the present invention, the charge device 19 can be arranged without extending farther out from the side of the shutter control part 18a. This can improve flexibility in designing the camera. In addition, the horizontal dimension of the camera body 11 is smaller than that in the conventional structure, allowing downsizing of the single-lens reflex camera 1.

Note that, although the location of the motor 19a is different from that in the conventional structure, the basic structure of the charge device 19 is the same as that in the conventional structure. As shown in FIG. 3, the driving-force transmission mechanism 19b of the charge device 19 includes a pinion gear a of the motor 19a, a reduction gear train b, a charge gear c, a charge cam d, a charge lever e, and a charged lever f. The driving force of the motor 19a is transmitted from the pinion gear a of the motor 19a to the charge gear c while being slowed down through the reduction gear train b. A contact roller e1 of the charge lever e is in contact with a cam surface d1 of the charge cam d on the upper surface of the charge gear c. The charge lever e is swingable about an axis Oe as a pivot point. The charge lever e is arranged such that its pressure roller e2 is located behind the shutter support plate 18b in the direction of the optical axis, and the axis Oe of the pivot point is located in front of the shutter support plate 18b in the direction of the optical axis. Then, when the charge gear c is rotates in one direction (X direction in FIG. 3) by the driving force of the motor 19a, the charge lever e swings about the axis Oe in the horizontal direction of the camera (Y direction in FIG. 3) so that the pressure roller e2 formed at the tip of the charge lever e will push the charged lever f of the shutter control part 18a. When the charged lever f is pushed, the charge springs of the shutter control part 18a are charged with the driving force of the motor 19a. Then, when a shutter button is pressed, each magnet is de-energized at predetermined timing to release each of the pair of shutter blades 18a1 from being retained in a closed position so that they will travel individually and sequentially under the force of each of the charge springs to obtain a predetermined exposure.

The mirror box device 20 has a reflecting mirror 20a positioned in front of the shutter device 18 in the direction of the optical axis. The reflecting mirror 20a can provide both an optical path (viewing optical path) reflecting a light beam from a subject to guide it into an observation optical system including a prism and the like provided above the reflecting mirror 20a, and an optical path (imaging optical path) transmitting the subject light beam to guide it into an image pickup device 14 located behind the reflecting mirror 20a in the direction of the optical axis.

A half mirror or rotatable reflecting mirror can be used as the reflecting mirror 20a. When a rotatable reflecting mirror is used, the reflecting mirror 20a is arranged inside the mirror box device 20 in such a manner to be rotatable between a viewing position at which it guides the subject light beam into the observation optical system to form the viewing optical path and a retracted position at which it flips up from the viewing position and guides the subject light beam into the image pickup device 14 to provide the imaging optical path.

FIG. 4 is a transversal-sectional view showing a second embodiment which is different in layout from the first embodiment. In this embodiment, the different point is that a shutter control part 18′a is arranged laterally opposite to that in the aforementioned embodiment, that is, when a photographer holds the camera to take a picture, the shutter control part 18′a is positioned on his or her left-hand side. The shutter control part 18′a is arranged behind a support plate 18′b in the direction of the optical axis and opposite to a camera grip 11′a of the camera body 11. Therefore, a charge device 19′ for charging the springs to drive the shutter blades included in the shutter control part 18′a and a motor 19′a for charging the shutter are also arranged opposite to the camera grip 11′a of the camera body 11.

As described above, according to the layouts in the aforementioned embodiments of the present invention, the charge device can be arranged without extending farther out from the side of shutter control part. This can reduce the horizontal dimension of the camera body, and hence downsize the single-lens reflex camera.

The present invention has a wide applicability to single-lens reflex cameras such as digital cameras and video cameras or camcorders.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A single-lens reflex camera comprising:
an imaging medium; and
a shutter device arranged in front of the imaging medium along the optical axis of the imaging medium,
wherein the shutter device comprises a support plate having an opening through which the imaging medium is exposed to a light beam from a subject, a pair of shutter blades which travel vertically across the opening with respect to the optical axis of the subject light beam to control the amount of exposure to the imaging medium, and a shutter control part as a drive part for driving the pair of shutter blades, which shutter control part is located at the side of the opening and behind the support plate in the direction of the optical axis.

2. The single-lens reflex camera according to claim 1, further comprising a mirror box device arranged in front of the shutter device in the direction of the optical axis and having a reflecting mirror which provides an optical path for guiding the subject light beam into an observation optical system and an optical path for guiding the subject light beam into the imaging medium.

3. The single-lens reflex camera according to claim 2, further comprising a shutter charge device for charging the shutter device, which has a portion arranged at the side of the mirror box device and in front of the shutter control part in the direction of the optical axis.

4. The single-lens reflex camera according to claim 1, further comprising a shutter charge device including a motor for charging the shutter device, wherein the shutter in the shutter device is charged by the driving force of the motor.

5. The single-lens reflex camera according to claim 4, wherein a charge lever of the shutter charge device is arranged to extend forward and backward across the support plate in the direction of the optical axis.

6. The single-lens reflex camera according to claim 1, wherein the imaging medium is a solid-state image pickup device.

7. The single-lens reflex camera according to claim 1, further comprising a motor for charging spring members for driving the shutter blades included in the shutter device, wherein the motor and the shutter control part are arranged on opposite sides of the support plate.

8. The single-lens reflex camera according to claim 1, wherein when a photographer holds the camera to take a picture, the shutter control part is positioned on his or her left-hand side.

9. A single-lens reflex camera comprising:
an imaging medium;
a movable mirror provided in front of a shutter device along the optical axis of the imaging medium to move between a viewing position at which it guides a light beam coming from a subject through a photographing lens into an observation optical system and a retracted position at which it is retracted from the subject light beam to allow the imaging medium to be exposed to the subject light beam; and
the shutter device including a support plate having an opening through which the imaging medium is exposed to the subject light beam, a pair of shutter blades arranged between the imaging medium and the movable mirror to travel across the opening vertically with respect to the optical axis of the subject light beam so as to control the amount of exposure to the imaging medium; and a shutter control part as a drive part for driving the pair of shutter blades, which is located at the side of the opening and behind the support plate in the direction of the optical axis.

10. The single-lens reflex camera according to claim 9, further comprising a motor for charging a spring member for driving the shutter blade included in the shutter device, wherein the motor is located at the side of the movable mirror and in front of the shutter control part in the direction of the optical axis.

11. The single-lens reflex camera according to claim 9, further comprising a shutter charge device for charging the shutter device, which has a portion arranged at the side of a mirror box device including the movable mirror and in front of the shutter control part in the direction of the optical axis.

12. The single-lens reflex camera according to claim 11, wherein a charge lever of the shutter charge device is arranged to extend forward and backward across the support plate in the direction of the optical axis.

13. The single-lens reflex camera according to claim 9, wherein the imaging medium is a solid-state image pickup device.

14. The single-lens reflex camera according to claim 9, wherein when a photographer holds the camera to take a picture, the shutter control part is positioned on his or her left-hand side.

15. A shutter device for a single-lens reflex camera comprising:
a support plate having an opening through which an imaging medium is exposed to a light beam from a subject;
a shutter blade for opening and closing the opening; and
a shutter control part for driving open and close movements of the shutter blade,
wherein the shutter control part is located behind the support plate in the direction of the optical axis.
